(19) United States
(12) Patent Application Publication
(10) Pub. No.: US 2013/0305899 A1
(43) Pub. Date: Nov. 21, 2013

(54) KEYBOARD MUSICAL INSTRUMENT

(71) Applicant: CASIO COMPUTER CO., LTD., Tokyo (JP)

(72) Inventors: Shigeyuki NAGATSUMA, Tokyo (JP); Kazuo SHIMADA, Tokyo (JP)

(73) Assignee: CASIO COMPUTER CO., LTD., Tokyo (JP)

(21) Appl. No.: 13/894,204

(22) Filed: May 14, 2013

(30) Foreign Application Priority Data
May 18, 2012 (JP) 2012-114387

(51) Int. Cl. G10C 3/12

(52) U.S. Cl. CPC G10C 3/12
USPC 84/423 R

(57) ABSTRACT

A keyboard musical instrument of the present invention includes a musical instrument case which is substantially in a box shape and whose front side is open upward, a keyboard section which is arranged in the musical instrument case and exposed to the upper front side of the musical instrument case, a keyboard lid which has a front lid and a rear lid that are foldable and coupled together and openably and closably covers the upper side of the keyboard section, a lid guide section which guides the keyboard lid to be folded and placed near the rear portion of the keyboard section when guiding the keyboard lid to expose the keyboard section upward, a loudspeaker which is arranged in the musical instrument case and positioned behind the keyboard section, and second sound emission holes provided in the upper portion of the musical instrument case.

### CROSS-REFERENCE TO RELATED APPLICATION

This application is based upon and claims the benefit of priority from the prior Japanese Patent Application No. 2012-114387, filed May 18, 2012, the entire contents of which are incorporated herein by reference.

### BACKGROUND OF THE INVENTION

1. Field of the Invention

The present invention relates to a keyboard musical instrument such as an electronic piano or an electronic organ.

2. Description of the Related Art

For example, an electronic keyboard musical instrument is known in which a keyboard section is provided in a musical instrument case whose front side is open upward, a keyboard lid is provided to openably and closably cover the keyboard section, a loudspeaker is mounted upward on the lower surface of the musical instrument case, and sound generated at the loudspeaker is emitted from inside the musical instrument case toward the front side of the musical instrument case, as described in Japanese Patent Application Laid-Open (Kokai) Publication No. 2011-28034.

The keyboard section in this electronic keyboard musical instrument includes a keyboard chassis arranged in the musical instrument case and a plurality of keys arranged in parallel to each other on the keyboard chassis in a manner to be rotatable in a vertical direction. This keyboard section is structured such that sound from the loudspeaker is emitted toward the front side of the musical instrument case through each gap among the plurality of keys.

Also, the keyboard lid is structured to be foldable at a hinge coupling a front lid and a rear lid together and be guided by a lid guide section. In this case, the lid guide section is structured such that, when the keyboard lid is opened to expose the keyboard section upward, the front lid, and the rear lid are bent at the hinge and the rear lid is positioned near the rear portion of the keyboard section.

As a result of this structure, in the electronic keyboard musical instrument, when the keyboard lid is opened to expose the keyboard section upward, the front lid is positioned near the upper portion of the musical instrument case with a small gap therebetween, and the rear lid is positioned near the rear portion of the musical instrument case with a small gap therebetween. Through these gaps, sound from the loudspeaker is emitted toward the front side of the musical instrument case.

In the structure of this electronic keyboard musical instrument, when a sound produced at the loudspeaker is passing through the inside of the musical instrument case to be emitted to the front side of the musical instrument case, the sound from the loudspeaker passes through each gap among the plurality of keys in the keyboard section, the small gap between the rear lid and the rear portion of the musical instrument case, and the small gap between the front lid and the upper portion of the musical instrument case, and then is emitted toward the front side of the musical instrument case. Accordingly, there is a problem in that sound from the loudspeaker cannot be efficiently and favorably emitted.

### SUMMARY OF THE INVENTION

The present invention has been conceived in light of the above-described problems. An object of the present invention is to provide a keyboard musical instrument capable of efficiently and favorably emitting sound from a loudspeaker.

In accordance with one aspect of the present invention, there is provided a keyboard musical instrument comprising: a musical instrument case whose front side is open upward; a keyboard section which is arranged in the musical instrument case and exposed to upper front side of the musical instrument case; a loudspeaker which is arranged in the musical instrument case and positioned behind the keyboard section; a sound emission hole which is provided in a top plate positioned at upper portion of the musical instrument case, and emits a sound produced from the loudspeaker; a keyboard lid which has a plurality of lid sections that are foldable and coupled together; and a lid guide section which guides the keyboard lid to be folded and placed in an area between rear portion of the keyboard section and the loudspeaker which is not blocking the sound emission hole, when upper side of the keyboard section is exposed.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is a sectional view of a first embodiment, in which the present invention has been applied to an electronic keyboard musical instrument;

FIG. 2 is a sectional view of the electronic keyboard musical instrument depicted in FIG. 1, in which a keyboard lid and a block lid have been opened for musical performance;

FIG. 3 is a plain view of main sections of the electronic keyboard musical instrument depicted in FIG. 2, in which the block lid has been removed;

FIG. 4 is an enlarged perspective view of main sections of the electronic keyboard musical instrument in FIG. 2, depicting a lid support member for opening and supporting the block lid;

FIG. 5 is an enlarged sectional view of main sections of the electronic keyboard musical instrument depicted in FIG. 2, in which the block lid has been opened and supported by the lid support member;

FIG. 6 is an enlarged sectional view of the main sections, in which the block lid depicted in FIG. 5 has been pushed up;

FIG. 7 is an enlarged sectional view of the main sections, in which the lid support member depicted in FIG. 6 has been rotated in a counterclockwise direction to be lowered in a direction of closing the block lid;

FIG. 8 is an enlarged sectional view of the main sections, in which the lid support member depicted in FIG. 7 has been accommodated in an accommodation recessed section of the block lid to cause the block lid to block second sound emission holes;

FIG. 9 is a sectional view of a second embodiment, in which the present invention has been applied to an electronic keyboard musical instrument; and

FIG. 10 is a plan view of main sections of the electronic keyboard musical instrument depicted in FIG. 9, in which a block lid has been removed.

### DETAILED DESCRIPTION OF THE PREFERRED EMBODIMENTS

### First Embodiment

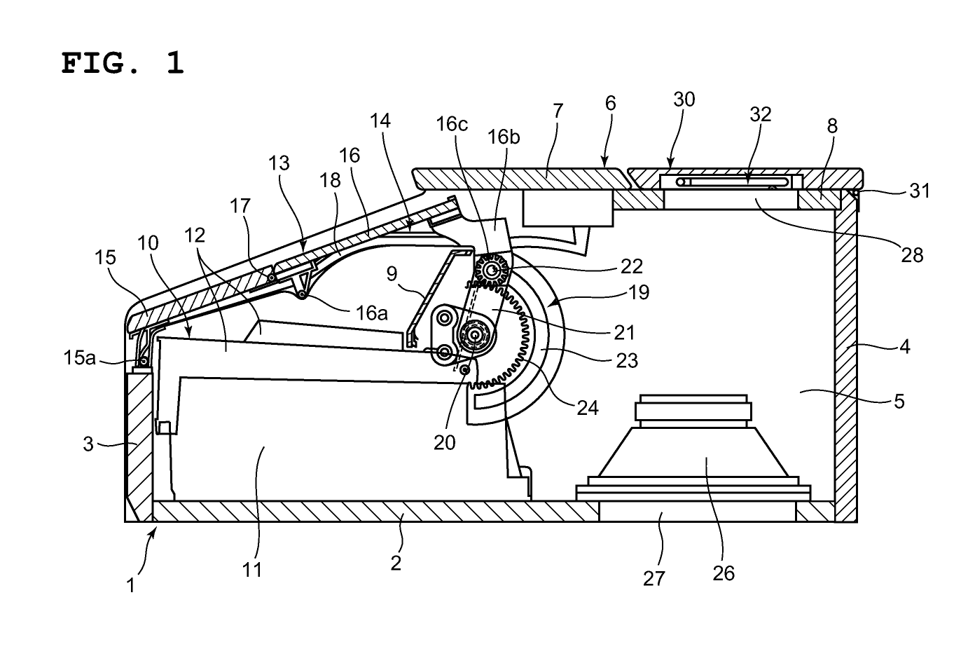

With reference to FIG. 1 to FIG. 8, a first embodiment in which the present invention has been applied to an electronic keyboard musical instrument is described below.

As depicted in FIG. 1 to FIG. 3, the electronic keyboard musical instrument includes a musical instrument case 1. The musical instrument case 1 is formed substantially in a horizontally elongated box shape with its upper front portion (upper left portion in FIG. 1) opened.

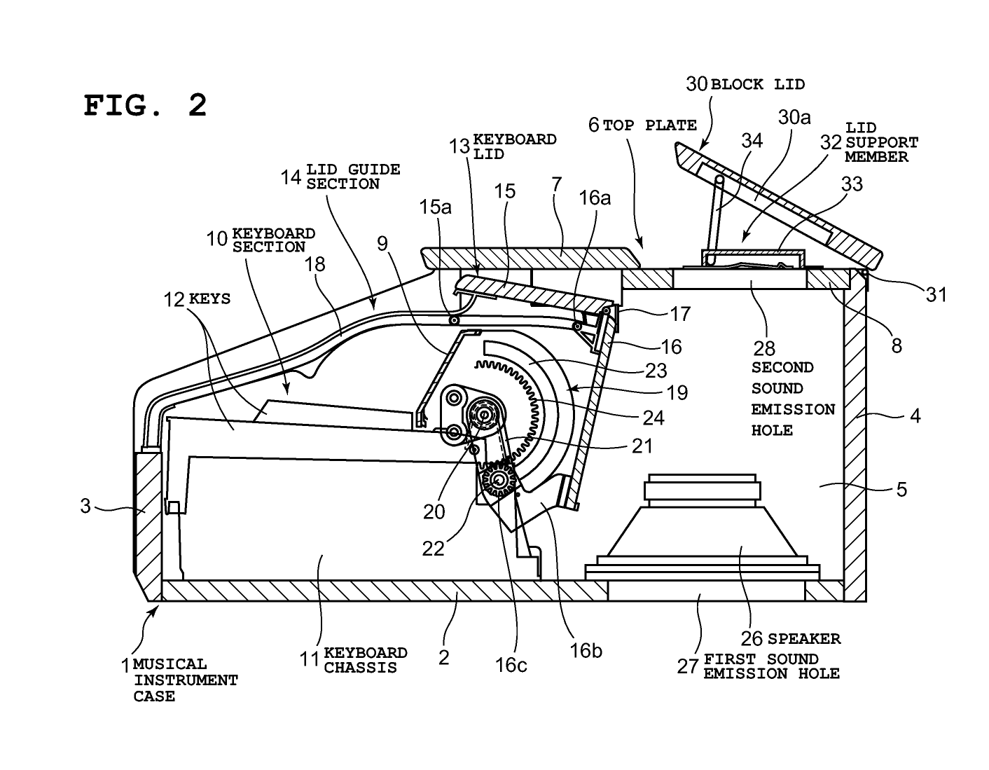

That is, as depicted in FIG. 1 and FIG. 2, the musical instrument case 1 includes a bottom plate 2, a front plate 3 provided upright at the front end (left end in FIG. 1) of the bottom plate 2, a rear plate 4 provided upright at the rear end (right end in FIG. 1) of the bottom plate 2, paired side plates 5 provided upright at the left and right side portions of the bottom plate 2 (both side portions on the front and back surfaces of the paper showing FIG. 1), and a top plate 6 provided on the upper portions of the paired side plates 5 and the rear plate 4.

In this case, as depicted in FIG. 1 and FIG. 2, the front plate 3 is formed such that the height is substantially half of the height of the rear plate 4. The paired side plates 5 are each formed such that the front end is slightly higher than the front plate 3, the height from a substantially intermediate portion in the front to rear direction (a horizontal direction in FIG. 1) to the rear side is equal to the height of the rear plate 4, and the portion from the front end to the intermediate portion is formed as an inclined portion that slants upward and rearward.

As depicted in FIG. 1 and FIG. 2, the top plate 6 includes a front top plate 7 and a rear top plate 8. In this case, the front top plate 7 is arranged on the upper front portions of the rear portions of the paired side plates 5. The rear top plate 8 is arranged on the upper rear portions of the rear portions of the paired side plates 5 and the upper portion of the rear plate 4. As a result, the musical instrument case 1 is formed substantially in a horizontally elongated box shape whose front side corresponding to the inclined portion of each of the paired side plates 5 is open upward.

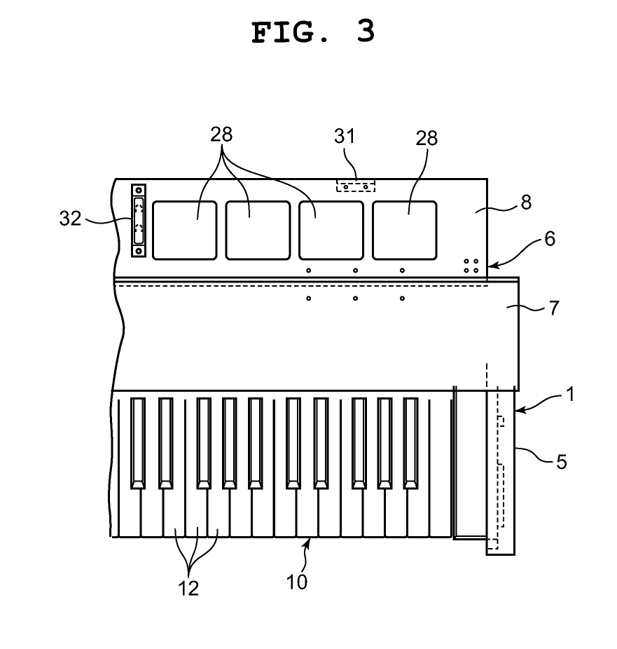

As depicted in FIG. 1 to FIG. 3, a keyboard section 10 is provided in the musical instrument case 1. The keyboard section 10 includes a keyboard chassis 11 arranged on the bottom plate 2 of the musical instrument case 1 and a plurality of keys 12 arranged in parallel to each other on the keyboard chassis 11 so as to be rotatable in a vertical direction. As depicted in FIG. 2 and FIG. 3, the keyboard section 10 is structured so that the plurality of keys 12 are exposed upward from the front side of the musical instrument case 1 and the keys in this state are operated by being pushed.

In the musical instrument case 1, a console panel 9 is provided obliquely from above the rear portion of the keyboard section 10 toward an area below the front portion of the top plate 6, as depicted in FIG. 1 and FIG. 2. Also, in the musical instrument case 1, a keyboard lid 13 is provided to operably and closably cover the upper side of the keyboard section 10 by a lid guide section 14. The keyboard lid 13 has a front lid 15 and a rear lid 16, and is structured to be foldable at a hinge 17 coupling the front lid 15 and the rear lid 16 together.

In this case, as depicted in FIG. 1 and FIG. 2, a guide shaft 15a is provided on the front end of the front lid 15 so as to project toward the paired side plates 5. On the front end of the rear lid 16, a guide shaft 16a is provided so as to project toward the paired side plates 5. On the rear end of the rear lid 16, a shaft mount plate 16b is mounted. On this shaft mount plate 16b, a pinion gear 16c is rotatably mounted.

As depicted in FIG. 1 and FIG. 2, the lid guide section 14 is structured so as to place the front lid 15 and the rear lid 16 substantially in a flat plate shape when the keyboard lid 13 covers the upper side of the keyboard section 10, and bend the front lid 15 and the rear lid 16 at the hinge 17 to place the keyboard lid 13 near the rear portion of the keyboard section 10 when the keyboard lid 13 is opened to expose the keyboard section 10 upward. In this case, the lid guide section 14 has a guide rail section 18 and a guide member 19.

As depicted in FIG. 1 and FIG. 2, the guide rail section 18 is provided on the inner surface of each of the paired side plates 5 so as to be inclined diagonally upward from above the front plate 3 toward the rear plate 4 via the upper side of the console panel 9. The guide rail section 18 is structured to guide the guide shaft 15a of the front lid 15 of the keyboard lid 13 and the guide shaft 16a of the rear lid 16 thereof. As a result, the guide rail section 18 is structured such that when the front lid 15 and the rear lid 16 cover the upper side of the keyboard section 10, the front lid 15 and the rear lid 16 are placed in a flat plate shape in a state of being tilted forward and downward, as depicted in FIG. 1.

As depicted in FIG. 1 and FIG. 2, the guide member 19 includes a support shaft 20 that is provided on the inner surfaces of portions of the side plates 5 located above the rear end of the keyboard section 10, an arm section 21 that is rotatably mounted on the support shaft 20, a coupling shaft 22 that couples a tip of the arm section 21 and the pinion gear 16c of the rear lid 16 together, a guide groove section 23 that is provided on each side. plate 5 and has an arc shape centering on the support shaft 20 so as to guide the coupling shaft 22, and a semi-circular-shaped guide gear wheel section 24 that rotates and moves by being engaged with the pinion gear 16c of the rear lid 16.

As a result, the lid guide section 14 is structured such that, when the front lid 15 and the rear lid 16 of the keyboard lid 13 are closed and cover the upper side of the keyboard section 10, the guide shaft 15a of the front lid 15 is positioned at the front end of the guide rail section 18, the guide shaft 16a of the rear lid 16 is positioned at an intermediate portion of the guide rail section 18, the coupling shaft 22 at the rear end of the rear lid 16 is positioned at the upper end of the guide groove section 23, and the pinion gear 16c is positioned at the upper end of the guide gear wheel section 24, whereby the front lid 15 and the rear lid 16 are placed in a flat plate shape in a state of being tilted forward and downward, as depicted in FIG. 1.

Also, this lid guide section 14 is structured such that, when the keyboard lid 13 is opened to expose the keyboard section 10 upward, the front lid 15 and the rear lid 16 are bent at the hinge 17, the guide shaft 15a of the front lid 15 is positioned at a portion of the guide rail section 18 above the rear portion of the keyboard section 10, the guide shaft 16a of the rear lid 16 is positioned at the rear end of the guide rail section 18, the coupling shaft 22 at the rear end of the rear lid 16 is positioned at the lower end of the guide groove section 23, and the pinion gear 16c is positioned at the lower end of the guide gear wheel section 24, whereby the rear lid 16 is bent with respect to the front lid 15, drooped to be near the rear portion of the keyboard section 10 such that the keyboard lid 13 covers the rear portion of the keyboard section 10, and positioned in an area where second sound emission holes 28 described further below are not blocked, as depicted in FIG. 2.

In the musical instrument case 1, a loudspeaker 26 is arranged to be oriented downward and positioned behind the keyboard section 10, as depicted in FIG. 1 and FIG. 2. This loudspeaker 26 is arranged on both sides of the arrangement direction of the keys 12, and positioned behind the rear lid 16 of the keyboard lid 13 which has been bent with respect to the front lid 15 and drooped to be near the rear portion of the keyboard section 10. In this case, a first sound emission hole 27 is provided in the bottom plate 2 of the musical instrument case I to emit sound from the loudspeaker 26 toward the lower side of the musical instrument case 1.

In addition, second sound emission holes 28 are provided in the rear top plate 8 of the top plate 6 of the musical instrument case 1 to emit sound from the loudspeaker 26 toward the upper side of the musical instrument case 1, as depicted in FIG. 1 to FIG. 3, in this case, the front top plate 7 is arranged higher than the rear top plate 8 and positioned above the rear portion of the keyboard section 10. When the keyboard lid 13 is opened to expose the keyboard section 10 upward, the upper surface of the front lid 15 comes near the front top plate 7. The rear top plate 8 is provided on the upper portions of the paired side plates 5 and the rear plate 4 such that the upper surface thereof is equal in height to the lower surface of the front top plate 7, and positioned above the loudspeaker 26.

As a result, as depicted in FIG. 1 to FIG. 3, the second sound emission holes 28 are provided on both sides of the rear top plate 8 positioned above the loudspeaker 26. On the upper surface of the rear top plate 8, a block lid 30 for blocking the second sound emission holes 28 is openably and closably provided. The block lid 30 is formed to be equal in thickness to the front top plate 7, and the rear end thereof is rotatably mounted on the upper end of the rear plate 4 by a hinge section 31. As a result, the block lid 30 is structured such that the upper surface thereof is equal in height to the upper surface of the front top plate 7 when the block lid 30 is placed to overlap with the rear top plate 8.

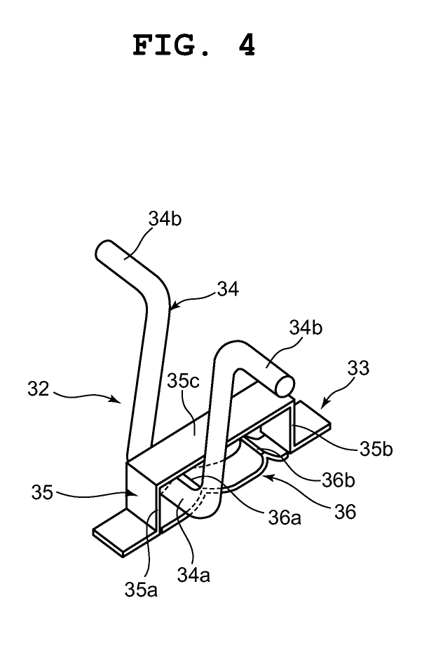

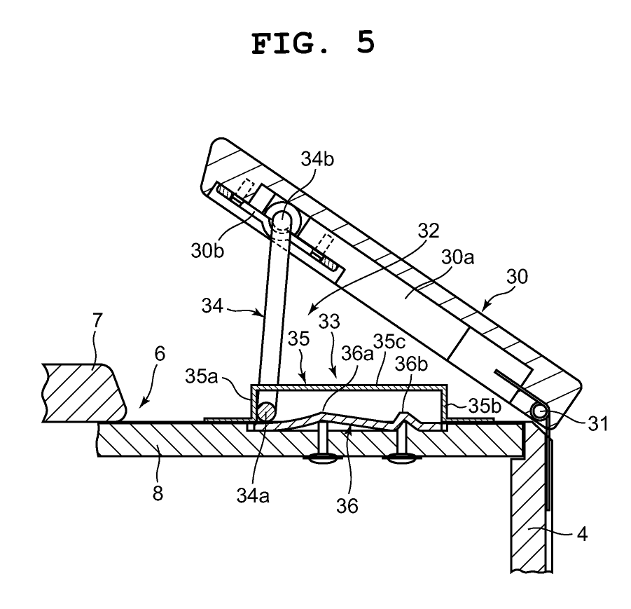

Also, this block lid 30 is structured to be supported by a lid support member 32 so that it is opened or closed, as depicted in FIG. 1 to FIG. 8. That is, as depicted in FIG. 4 and FIG. 5, the lid support member 32 includes a support guide section 33 that is provided on the rear top plate 8 and a support arm section 34 that is movably supported by the support guide section 33. The support guide section 33 includes a guide plate 35 and a position limiting plate 36.

As depicted in FIG. 4 to FIG. 8, the guide plate 35 is structured by a main body section 35c being formed to straddle the upper portions of a front mount section 35a and a rear mount section 35b, and guides the support arm section 34 in the front and back directions of the rear top plate 8. The position limiting plate 36, which limits the position of the support arm section 34, is arranged below the main body section 35c of the guide plate 35, and includes a front-side position limiting section 36a and a rear-side position limiting section 36b. The front-side position limiting section 36a is formed in a gently-sloped mountain shape, and the rear-side position limiting section 36b is formed in a steep mountain shape.

As depicted in FIG. 4 to FIG. 8, the support arm section 34 is formed by bending a round bar substantially in a U shape and further folding both ends laterally. The bottom portion of the support arm section 34 is substantially in a U shape formed as a support section 34a guided and supported by the support guide section 33, and each end portion is formed as an arm shaft 34b rotatably mounted on the block lid 30. In this case, the lower surface of the block lid 30 are provided with an accommodation recessed section 30a where the support guide section 33 and the support arm section 34 are inserted and a bearing fitting 30b for rotatably mounting the arm shaft 34b of the support arm section 34 in the accommodation recessed section 30a.

As a result, as depicted in FIG. 5, the lid support member 32 is structured such that, when the block lid 30 is opened, the support arm section 34 rotates by its own weight around the arm shaft 34b to cause the support section 34a to be positioned at the front end of the support guide section 33 and abut on the front mount section 35a of the guide plate 35, and thereby limits the position of the support section 34a. In this state, the block lid 30 is supported by the support arm section 34.

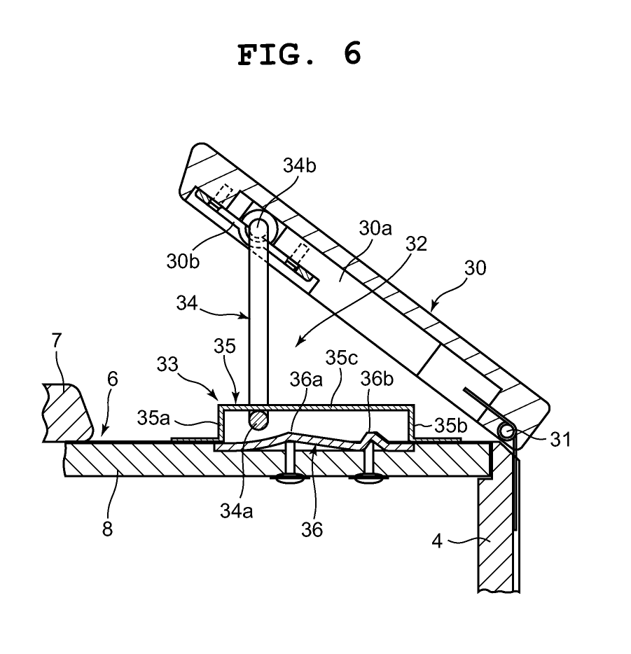

As depicted in FIG. 6, the lid support member 32 is structured such that, if the block lid 30 is slightly lifted when closed, the support section 34a of the support arm section 34 abuts from below on the main body section 35c of the guide plate 35 of the support guide section 33 to limit upward rotation of the block lid 30.

Here, as depicted in FIG. 6, the lid support member 32 is structured such that the support section 34a of the support arm section 34 comes near the front-side position limiting section 36a without overshooting the front-side position limiting section 36a of the position limiting plate 36 of the support guide section 33, and thereby prevents the block lid 30 from being inadvertently closed.

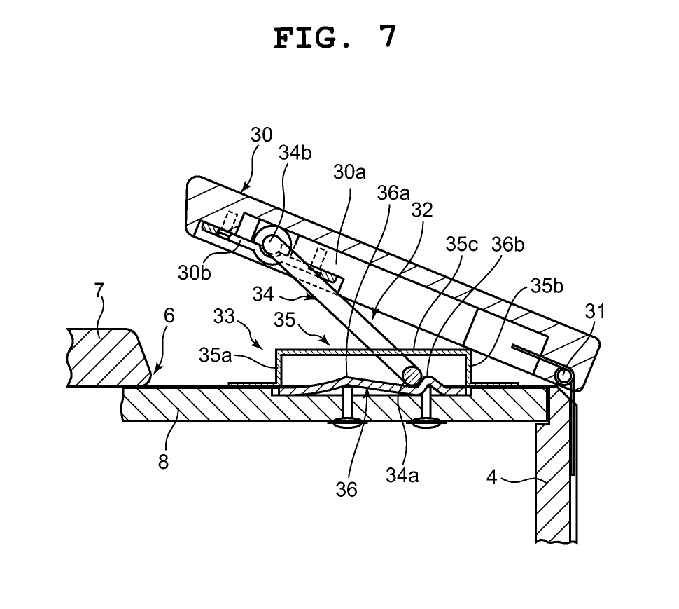

Also, as depicted in FIG. 7, the lid support member 32 is structured such that, when the support arm section 34 is rotated in a counterclockwise direction to cause, the support section 34a to overpass the front-side position limiting section 35a, the support section 34a moves above the position limiting plate 36 while rotating in a direction of closing the block lid 30 to abut on the rear-side position limiting section 36b, and thereby limits rotation of the block lid 30 in the closing direction and prevents the block lid 30 from being completely closed.

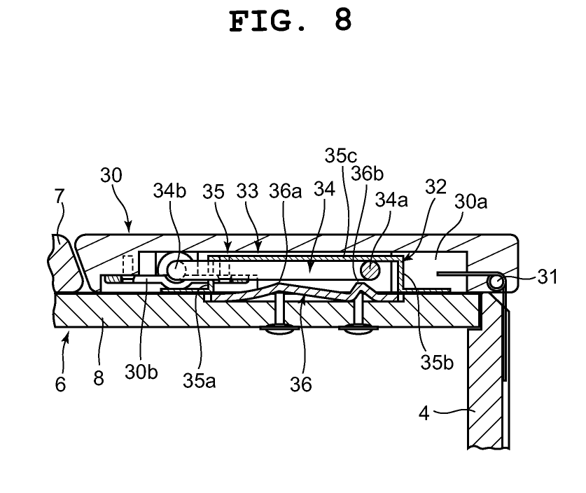

Moreover, as depicted in FIG. 7, the lid support member 32 is structured such that, when the support section 34a of the support arm section 34 is lifted to the upper side of the rear-side position limiting section 36b for removal, the support section 34a overpasses the rear-side position limiting section 36b to be positioned at the rear end of the support guide section 33 while the support arm section 34 is rotating in the counterclockwise direction, and the support section 34a abuts on the rear mount section 35b of the guide plate 35 to be limited in position as depicted in FIG. 8.

As a result, as depicted in FIG. 1 and FIG. 8, the lid support member 32 is structured to be inserted for accommodation in the accommodation recessed section 30a provided in the lower surface of the block lid 30, whereby the block lid 30 comes in close contact with the upper surface of the rear top plate 8, and blocks the second sound emission holes 28.

Next, the operation of the electronic keyboard musical instrument is described.

For musical performance with the electronic keyboard musical instrument, the keyboard lid 13 is first opened to expose the keyboard section 10 upward. Here, when the front end of the front lid 15 is lifted and moved rearward, the guide shaft 15a of the front lid 15 and the guide shaft 16a of the rear lid 16 move along the guide rail section 18, and the coupling shaft 22 of the rear lid 16 moves along the guide groove section 23. In addition, the pinion gear 16c moves by being engaged with the guide gear wheel section 24, and the front lid 15 and the rear lid 16 gradually bend at the hinge 17 to move toward the rear side inside the musical instrument case 1.

Then, the guide shaft 15a of the front lid 15 is positioned in a portion of the guide rail section 18 located above the rear portion of the keyboard section 10, the guide shaft 16a of the rear lid 16 is positioned in the rear end of the guide rail section 18, the coupling shaft 22 at the rear end of the rear lid 16 is positioned at the lower end of the guide groove section 23, and the pinion gear 16c is positioned at the lower end of the guide gear wheel section 24, whereby the rear lid 16 bends with respect to the front lid 15, and droops near the rear portion, of the keyboard section 10 inside the musical instrument case 1.

As a result, the keyboard lid 13 covers the rear portion of the keyboard section 10, as depicted in FIG. 2. Here, the rear lid 16 is placed between the rear portion of the keyboard section 10 and the loudspeaker 26 for partition. In this state, since the keyboard section 10 has been opened upward to expose the plurality of keys 12 upward, musical performance can be made. In this state, before musical performance, the block lid 30 of the top plate 6 is opened to expose the second sound emission holes 28.

Here, when the front end of the block lid 30 is lifted, the support section 34a moves on the position limiting plate 36 of the support guide section 33 while the support arm section 34 of the lid support member 32 is automatically rotating by its own weight about the arm shaft 34b, and sequentially overpasses the rear-side position limiting section 36b and the front-side position limiting section 36a of the position limiting plate 36. Accordingly, the support section 34a abuts on the front mount section 35a of the guide plate 35 of the support guide section 33, whereby the block lid 30 is supported by the support arm section 34 in a state of being opened above the rear top plate 8 of the top plate 6.

In this state, when the plurality of keys 12 of the keyboard section 10 exposed upward from the front side of the musical instrument case 1 are pressed for musical performance, musical sounds according to the pressing operations are produced. In this case, of the musical sounds produced from the loudspeaker 26, high-pitched sounds are emitted from the first sound emission hole 27 provided on the bottom plate 2 of the musical instrument case 1 toward the lower side of the musical instrument case 1. Also, low-pitched sounds thereof are emitted from the second sound emission holes 28 provided on the rear top plate 8 of the top plate 6 of the musical instrument case 1 toward the upper side of the musical instrument case 1, and the emitted sounds are favorably emitted toward the front side of the musical instrument case 1 via the block lid 30.

In this case, a low-pitched sound is emitted from the second sound emission holes 28 to the upper side of the musical instrument case 1. Also, it is emitted through a space between the front lid 15 of the keyboard lid 13 and the front top plate 7 of the top plate 6 toward the front side of the musical instrument case 1. Moreover, it is emitted from the lower side of the rear lid 16 of the keyboard lid 13 through the inside of the keyboard chassis 11 toward the front side of the musical instrument case 1 from each gap among the plurality of keys 12. As a result, musical sound produced from the loudspeaker 26 is efficiently emitted from the musical instrument case 1.

On the other hand, the keyboard lid 13 is closed to cover the keyboard section 10 and the block lid 30 is closed to block the second sound emission holes 28 when musical performance is not made. Here, when the front end of the front lid 15 of the keyboard lid 13 is drawn toward the front side of the musical instrument case 1, the guide shaft 15a of the front lid 15 and the guide shaft 16a of the rear lid 16 move along the guide rail section 16, and the coupling shaft 22 of the rear lid 16 moves along the guide groove section 23. In addition, the pinion gear 16c moves by being engaged with the guide gear wheel section 24, and the front lid 15 and the rear lid 16 gradually bend at the hinge 17 to move toward the front side of the musical instrument case 1.

Then, the guide shaft 15a of the front lid 15 is positioned at the front end of the guide rail section 18 above the front plate 3 of the musical instrument case 1, the guide shaft 16a of the rear lid 16 is positioned at the intermediate portion of the guide rail section 18, the coupling shaft 22 at the rear end of the rear lid 16 is positioned at the upper end of the guide groove section 23, and the pinion gear 16c is positioned at the upper end of the guide gear wheel section 24, whereby the front lid 15 and the rear lid 16 are placed in a flat plate shape in a state of being inclined forward and downward, and covers the keyboard section 10.

Here, the block lid 30 is closed to block the second sound emission holes 28. In this case, when the block lid 30 is slightly lifted, the support section 34a of the support arm section 34 of the lid support member 32 abuts from below on the main body section 35c of the guide plate 35 of the support guide section 33 to limit the upward rotation of the block lid 30. Here, as depicted in FIG. 6, the support section 34a of the support arm section 34 comes near the front-side position limiting section 36a without overshooting the front-side position limiting section 36a of the position limiting plate 36 of the support guide section 33. Thus, the block lid 30 is prevented from being inadvertently closed.

In this state, when the support arm section 34 is rotated in the counterclockwise direction to cause the support section 34a to overpass the front-side position limiting section 36a as depicted in FIG. 7, the support section 34a moves above the position limiting plate 36 while rotating in the direction of closing the block lid 30 and abuts on the rear-side position limiting section 36b. As a result, the rotation of the block lid 30 is limited to prevent the block lid 30 from being completely closed, and an injury to a hand by being pinched between the block lid 30 and the rear top plate 8 can be prevented.

Thereafter, as depicted in FIG. 8, when the support section 34a of the support arm section 34 is lifted to the upper side of the front-side position limiting section 36b so as to be removed from the rear-side position limiting section 36b, the support section 34a overpasses the rear-side position limiting section 36b to be positioned at the rear end of the support guide section 33 while the support arm section 34 is again rotating, and abuts on the rear mount section 35b of the guide plate 35 so as to be limited in position. Here, the lid support member 32 is accommodated in the accommodation recessed section 30a of the close lid 30, and the close lid 30 is placed above the rear top plate 8 to block the second sound emission holes 28.

As such, the electronic keyboard musical instrument includes the musical instrument case 1 which is substantially in a box shape and the front side is open upward, the keyboard section 10 which is arranged in the musical instrument case 1 and exposed to the upper front side of the musical instrument case 1, the keyboard lid 13 which has the front lid 15 and the rear lid 16 that are foldable and coupled together and openably and closably covers the upper side of the keyboard section 10, the lid guide section 14 which guides the keyboard lid 13 so that it opens or closes, and bends the keyboard lid 13 so that it is placed near the rear portion of the keyboard section 10 when the keyboard section 10 is exposed upward, and the loudspeaker 26 which is arranged in the musical instrument case 1 and positioned behind the keyboard section 10. When exposing the keyboard section 10 upward, the keyboard lid 13 is bent and placed between the rear portion of the keyboard section 10 and the loudspeaker 26 and, since the second sound emission holes 28 have been provided in the upper portion of the musical instrument case 1, sound from the loudspeaker 26 is efficiently and favorably emitted.

That is, in the electronic keyboard musical instrument, when the keyboard section 10 is pressed to produce a musical sound from the loudspeaker 26 with the keyboard lid 13 being opened to expose the keyboard section 10 upward, the musical sound is reliably and favorably emitted from the second sound emission holes 28 provided in the musical instrument case 1 to the outside of the musical instrument case 1. Thus, in this keyboard musical instrument , sound from the loudspeaker 26 can be efficiently and favorably emitted.

Also, in the electronic keyboard musical instrument, the lid guide section 14, which guides the keyboard lid 13 so that it opens or closes, causes the front lid 15 and the rear lid 16 to be placed substantially in a flat plate shape when the upper side of the keyboard section 10 is covered by the keyboard lid 13, and bends the keyboard lid 13 so that it is placed near the rear portion of the keyboard section 10 and positioned between the rear portion of the keyboard section 10 and the loudspeaker 26 when the keyboard lid 13 is opened to expose the keyboard section 10 upward. Therefore, the rear portion of the keyboard section 10 can be covered by the front lid 15 and the rear lid 16. Also, the space between the rear portion of the keyboard section 10 and the loudspeaker 26 can be sectioned by the rear lid 16. As a result, an acoustic space can be formed in an area behind the keyboard section 10 in the musical instrument case 1.

In this case, the loudspeaker 26 is arranged to be oriented downward in the musical instrument case 1, and the second sound emission holes 28 are provided in the upper portion of the musical instrument case 1 so as to be positioned above the loudspeaker 26. As a result, of musical sounds produced from the loudspeaker 26, low-pitched sounds are emitted from the second sound emission holes 28 provided in the top plate 6 of the musical instrument case 1 toward the upper side of the musical instrument case 1, and high-pitched sounds are emitted from the first sound emission hole 27 provided in the bottom plate 2 of the musical instrument case 1 toward the lower side of the musical instrument case 1. For this reason, musical sound produced from the loudspeaker 26 can be efficiently and favorably emitted from the musical instrument case 1.

Here, of musical sounds produced from the loudspeaker 26, a low-pitched sound is emitted from the second sound emission holes 28 provided in the top plate 6 of the musical instrument case 1 toward the upper side of the musical instrument case 1. Also, it is emitted through the space between the front lid 15 of the keyboard lid 13 and the front top plate 7 of the top plate 6 toward the front side of the musical instrument case 1. Moreover, it is emitted from the lower side of the rear lid 16 of the keyboard lid 13 through the inside of the keyboard chassis 11 toward the front side of the musical instrument case 1 from each gap among the plurality of keys 12. Thus, also with this, sound produced from the loudspeaker 26 can be efficiently and favorably emitted from the musical instrument case 1.

Moreover, in the electronic keyboard musical instrument, the block lid 30 for blocking the second sound emission holes 28 is openably and closably provided on the upper portion of the musical instrument case 1. As a result, by opening the block lid 30 at musical performance, sound from the loudspeaker 26 is emitted from the second sound emission holes 28 to the upper side of the musical instrument case 1, and then emitted toward the front side of the musical instrument case 1 via the block lid 30. Also, the block lid 30 blocks the second sound emission holes 28 when musical performance is not made, and thereby prevents foreign substances such as dust from entering the inside of the musical instrument case 1 through the second sound emission holes 28.

Furthermore, the electronic keyboard musical instrument includes the lid support member 32 which supports the block lid 30 so that it opens and closes. Therefore, with the lid support member 32, the block lid 30 can be safely and reliably supported when it is open. In this case, the lid support member 32 includes the support guide section 33 provided on the rear top plate 8 and the support arm section 34 movably supported by the support guide section 33. Therefore, when the block lid 30 is opened, the support arm section 34 is operated by its own weight, and the support arm section 34 is held upright by the support guide section 33. With this support arm section 34, the block lid 30 can be reliably and stably supported when it is open.

That is, the support guide section 33 includes the guide plate 35 for guiding the support arm section 34 in the front and back directions of the rear top plate 8 and the position limiting plate 36 for limiting the position of the support arm section 34. The support arm section 34 includes the support section 34a formed by folding a round bar substantially in a U shape and guided and supported by the support guide section 33 and the arm shaft 34h rotatably mounted on the block lid 30. Therefore, when the block lid 30 is opened, the support arm section 34 can be held upright by the support guide section 33.

In this case, the guide plate 35 is structured such that the main body section 35c is formed to straddle the upper portions of the front mount section 35a and the rear mount section 35b. The position limiting plate 36 is arranged on the lower side of the main body section 35c of the guide plate 35, and includes the front-side position limiting section 36a formed in a gently-sloped mountain shape and the rear-position limiting section 36b formed in a steep mountain shape. Therefore, when the block lid 30 is opened, the support section 34a of the support arm section 34 can be held with its position being reliably limited by the front mount section 35a of the guide plate 35. When closing the block lid 30, the user can safely close it by the position of the support section 34a of the support arm section 34 being limited by the front-side position limiting section 36a and the rear-side position limiting section 36b of the position limiting plate 36.

That is, when the block lid 30 is slightly lifted to be closed, the support section 34a of the support arm section 34 of the lid support member 32 abuts from below on the main body section 35c of the guide plate 35 of the support guide section 33. With this, upward rotation of the block lid 30 can be limited. Here, the support section 34a of the support arm section 34 comes near the front-side position limiting section 36a without overshooting the front-side position limiting section 36a of the position limiting plate 36 of the support guide section 33. Therefore, the block lid 30 can be prevented from being inadvertently closed.

Also in this state, when the support arm section 34 is rotated in a counterclockwise direction to cause the support section 34a to overpass the front-side position limiting section 36a, the support section 34a moves above the position limiting plate 36 while rotating in the direction of closing the block lid 30 and abuts on the rear-side position limiting section 36b. Therefore, the block lid 30 can be prevented from being completely closed. As a result, an injury to a hand by being pinched between the block lid 30 and the rear top plate 8 can be prevented.

Moreover, in this state, when the support section 34a of the support arm section 34 is lifted to the upper side of the front-side, position limiting section 36b to be removed from the rear-side position limiting section 36b, the support section 34a overpasses the rear-side position limiting section 36b while the support arm section 34 is again rotating. Accordingly, the support arm section 34 abuts on the rear mount section 35b of the guide plate 35 and the position thereof is reliably limited.

In this case, since the block lid 30 is provided with the accommodated recessed section 30a for accommodating the lid support member 32, when the support arm section 34 abuts on the rear mount section 35b of the guide plate 35 to be limited in position, the lid support member 32 can be accommodated in the accommodation recessed section 30a of the block lid 30. As a result, the block lid 30 can be arranged to come in close contact with the upper surface of the rear top plate 8, and the second sound emission holes 28 can be reliably and favorably blocked.

### Second Embodiment

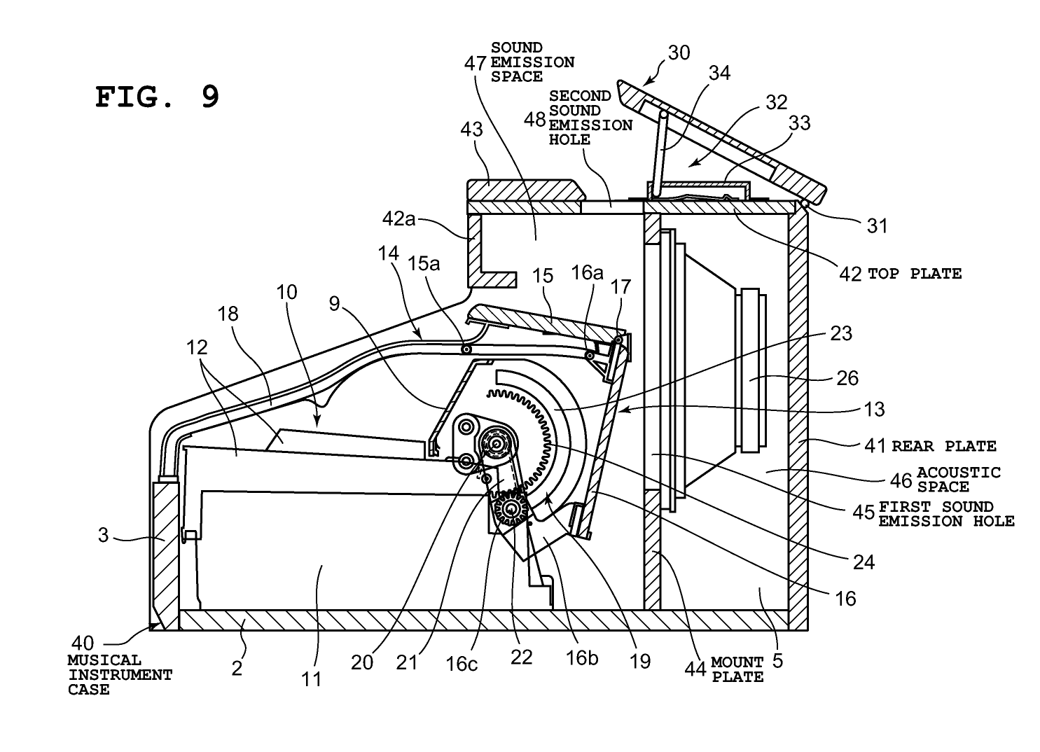

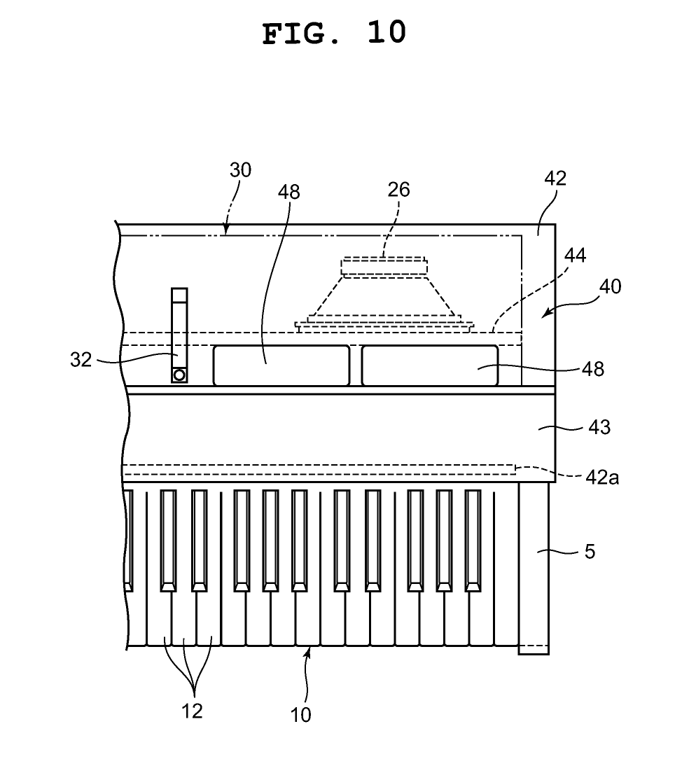

Next, with reference to FIG. 9 and FIG. 10, a second embodiment in which the present invention has been applied to an electronic keyboard musical instrument is described. Note that components identical to those in the first embodiment depicted in FIG. 1 to FIG. 8 are provided with the same reference numerals for description.

As depicted in FIG. 9, the electronic keyboard musical instrument has a structure that is substantially the same as that of the first embodiment except that the loudspeaker 26 is arranged in a musical instrument case 40 to be oriented forward.

That is, as depicted in FIG. 9, the musical instrument case 40 has a rear plate 41 formed higher than the outer diameter of the loudspeaker 26. As a result, the rear plate 41 is formed higher than the rear plate 4 of the first embodiment. Accordingly, the paired side plates 5 are formed such that the height form its intermediate portion to its rear side is higher than that of the side plates 5 of the first embodiment. Also, a top plate 42 is arranged across the upper portion of the rear plate 41 and the upper portions of the rear side of the paired side plates 5. The front end of the top plate 42 is provided with a front-hanging plate 42a positioned near the upper side of the keyboard lid 13, and the front portion of the top plate 42 has a front top plate 43 arranged thereon.

Also, in the musical instrument case 40, a mount plate 44 for partitioning into the keyboard section 10 and the loudspeaker 26 is provided, which is positioned behind the keyboard lid 13 placed near the rear portion of the keyboard section 10, as depicted in FIG. 9. The lower end of the mount plate 44 is mounted on the bottom plate 2 and the upper end is mounted on the lower surface of the top plate 42. On the rear surface (right side surface in FIG. 9) of the mount plate 44, the loudspeaker 26 is mounted to be oriented forward. In this case, a first sound emission hole 45 is provided on the mount plate 44, corresponding to the loudspeaker 26.

With this, in the musical instrument case 40, an acoustic space 45 is formed on the rear side of the mount plate 44, and a sound emission space 47 is formed on the front side of the mount plate 44, as depicted in FIG. 9. That is, the acoustic space 46 is formed between the mount plate 44 and the rear plate 41, and the sound emission space 47 is formed in an area surrounded by the keyboard lid 13 positioned on the front side of the loudspeaker 26, the top plate 42, and the mount plate 44.

The top plate 42 is provided with second sound emission holes 48 which correspond to the sound emission space 47 positioned on the front side of the loudspeaker 26. On the top plate 42, as with the first embodiment, the block lid 30 for blocking the second sound emission holes 48 is provided. As with the first embodiment, the block lid 30 is structured such that the rear end is rotatably mounted by the hinge 31 on the upper end of the rear plate 41, and is supported by the lid support member 32 so that it is opened or closed.

When opened to expose the keyboard section 10 upward, the keyboard lid 13 is placed in an area where it does not block the second sound emission holes 48, as with the first embodiment.

Next, the operation of the electronic keyboard musical instrument described above is described.

At the time of musical performance for which the keyboard lid 13 is opened and the plurality of keys 12 of the keyboard section 10 are pressed, the front end of the block lid 30 is lifted, as in the case of the first embodiment. Then, the block lid 30 is opened to be inclined on the top plate 42, and supported by the support arm section 34. In this state, when the plurality of keys 12 of the keyboard section 10 exposed upward from the front side of the musical instrument case 1 are pressed for musical performance, musical sounds according to the pressing operations are produced from the loudspeaker 26.

Here, of the musical sounds produced from the loudspeaker 26, high-pitched sounds are emitted from the first sound emission hole 45 of the mount plate 44 to the sound emission space 47 in the musical instrument case 40. The sounds emitted to the sound emission space 47 are emitted from the second sound emission holes 48 of the top plate 42 to the upper side of the musical instrument case 40, and then emitted toward the front side of the musical instrument case 1 by the block lid 30.

In this case, the sounds emitted to the sound emission space 47 are emitted from the second, sound emission holes 48 to the upper side of the musical instrument case 40. Also, they are emitted toward the front side of the musical instrument case 40 by passing through a space between the front lid 15 of the keyboard lid 13 and the front-hanging plate 42a of the top plate 42. Moreover, they are emitted toward the front side of the musical instrument case 40 from each gap among the plurality of keys 12 by passing through the inside of the keyboard chassis 11 from the lower side of the rear lid 16 of the keyboard lid 13. As a result, the musical sounds produced from the loudspeaker 26 are efficiently and favorably emitted from the musical instrument case 40.

As such, with the electronic keyboard musical instrument operations and effects similar to those of the first embodiment can be achieved. In addition, since the loudspeaker 26 is arranged to be oriented forward in the musical instrument case 40 and the second sound, emission holes 48 are provided at positions on the front side of the loudspeaker 26 in the top plate 42 of the musical instrument case 40, high-pitched sounds among musical sounds produced from the loudspeaker 26 can be emitted from the second sound emission holes 48 provided in the top plate 42 of the musical instrument case 40 toward the upper side of the musical instrument case 40. As a result of this structure, musical sounds produced from the loudspeaker 26 can be efficiently and favorably emitted from the musical instrument case 40.

In this case, the mount plate 44 for partitioning into the keyboard section 10 and the loudspeaker 26 is provided to be positioned behind the keyboard lid 13 placed near the rear portion of the keyboard section 10. With this mount plate 44, the sound emission space 47 is provided between the keyboard lid 13 and the musical instrument case 40, and the second sound emission holes 48 are provided in the top plate 42 of the musical instrument case 40, corresponding to the sound emission space 47. As a result, of musical sounds produced from the loudspeaker 26, high-pitched sounds can be reliably emitted to the sound emission space 47 between the keyboard lid 13 and the musical instrument case 40, and the sound emitted to the sound emission space 47 can be favorably emitted from the second sound emission holes 48 to the upper side of the musical instrument case 40.

Also here, when high-pitched sounds among musical sounds produced from the loudspeaker 26 are emitted from the second sound emission holes 48 provided on the top plate 42 of the musical instrument case 40 toward the upper side of the musical instrument case 40, the emitted sounds can be emitted toward the front side of the musical instrument case 40 by the block lid 30, as in the case of the first embodiment. By this structure as well, musical sounds produced from the loudspeaker 26 can be efficiently and favorably emitted from the musical instrument case 40.

Moreover, the sounds emitted to the sound emission space 47 can be emitted toward the front side of the musical instrument case 40 through a space between the front lid 15 of the keyboard lid 13 and the top plate 42. Also, they can be emitted toward the front side of the musical instrument case 40 from each gap among the plurality of keys 12 by passing through the inside of the keyboard chassis 11 from the lower side of the rear lid 16 of the keyboard lid 13. By this structure as well, musical sounds produced, from the loudspeaker 26 can be efficiently and favorably emitted from the musical instrument case 40.

In the above-described first and second embodiments the loudspeaker 26 is arranged to be oriented downward in the musical instrument case 1 or oriented frontward in the musical instrument case 40. However, the present invention is not limited thereto. For example, the loudspeaker 26 may be arranged to be oriented upward in the musical instrument case 1 or 40.

Also, in the above-described first and second embodiments, the keyboard lid 13 has the front lid 15 and the rear lid 16 coupled together with the hinge 17. However, the present invention is not limited thereto. For example, a structure may be adopted in which the keyboard lid 13 is divided into many lid sections, and they are sequentially coupled with a bendable coupling member such as a hinge.

While the present invention has been described with reference to the preferred embodiments, it is intended that the invention be not limited by any of the details of the description therein but includes all the embodiments which fall within the scope of the appended claims.

What is claimed is:

1. A keyboard musical instrument comprising:
a musical instrument case whose front side is open upward;
a keyboard section which is arranged in the musical instrument case and exposed to upper front side of the musical instrument case;
a loudspeaker which is arranged in the musical instrument case and positioned behind the keyboard section;
a sound emission hole which is provided in a top plate positioned at upper portion of the musical instrument case, and emits a sound produced from the loudspeaker;
a keyboard lid which has a plurality of lid sections that are foldable and coupled together; and
a lid guide section which guides the keyboard lid to be folded and placed in an area between rear portion of the keyboard section and the loudspeaker which is not blocking the sound emission hole, when upper side of the keyboard section is exposed.

2. The keyboard musical instrument according to claim 1, wherein the lid guide section guides the plurality of lid sections to be placed in a flat plate shape when the keyboard lid covers the upper side of the keyboard section, and guides the plurality of lid sections such that the plurality of lid sections are folded, placed near the rear portion of the keyboard section, and positioned between the rear portion of the keyboard section and the loudspeaker, when the keyboard lid is opened to expose the upper side of the keyboard section.

3. The keyboard musical instrument according to claim 1, wherein the loudspeaker is arranged in the musical instrument case so as to be oriented downward, and the sound emission hole is provided in an area above the loudspeaker which is located in the upper portion of the musical instrument case.

4. The keyboard musical instrument according to claim 1, wherein the loudspeaker is arranged in the musical instrument case so as be oriented forward, and the sound emission hole is provided in an area in front of the loudspeaker which is located in the upper portion of the musical instrument case.

5. The keyboard musical instrument according to claim 4, wherein the musical instrument case has provided therein a mount member for partitioning into the keyboard section and the loudspeaker which is arranged behind the keyboard lid placed near the rear portion of the keyboard section, and a sound emission space which is formed between the keyboard lid and the musical instrument case by the mount member; and
wherein the sound emission hole is provided in the upper portion of the musical instrument, corresponding to the sound emission space.

6. The keyboard musical instrument according to claim 1, wherein the musical instrument case has a block lid openably and closably provided thereon which blocks the sound emission hole.

7. The keyboard musical instrument according to claim 6, further comprising:
a lid support member which supports the block lid so that the block lid opens or closes.
